(19) United States
(12) Patent Application Publication
(10) Pub. No.: US 2007/0015385 A1
(43) Pub. Date: Jan. 18, 2007

(54) Connector with double row terminals

(76) Inventor: Johnson Yang, Jhonghe City (TW)

Correspondence Address: CHARLES E. BAXLEY, ESQ., 90 JOHN STREET, THIRD FLOOR, NEW YORK, NY, 10038, US

(21) Appl. No.: 11/298,073

(22) Filed: Dec. 9, 2005

Related U.S. Application Data
(63) Continuation-in-part of application No. 11/182,453, filed on Jul. 15, 2005, now abandoned.

(51) Int. Cl. H01R 12/00

(52) U.S. Cl. 439/79

(57) ABSTRACT

A connector with double row terminals comprises: a base having a first row of inserting holes and a second row of inserting holes, a first row of terminals each having an inserting portion and a soldering portion, the inserting portion being inserted in the first row of inserting holes, a second row of terminals each having an inserting portion and a soldering portion, the inserting portion being inserted in the second row of inserting holes. The soldering portion of the second terminals and the soldering portion of the first row of terminals are oppositely arranged, and the two rows of terminals are arranged in a staggered manner.

This application is a continuation of part of U.S. patent application Ser. No. 11/182,453 filed on Jul. 15, 2005, which claims the benefit of the earlier filing date.

### BACKGROUND OF THE INVENTION

1. Field of the Invention

The present invention relates to a connector, and more particularly to a connector with double row terminals.

2. Description of the Prior Art

With the development of science, all kinds of electronic products are becoming smaller and lighter, such as notebook, PDA, cell phone, and etc, and through a connector, the electronic products can be connected to peripheral equipments. Therefore, connector is one of the indispensable components of the electronic products.

Referring to FIGS. 1 and 2, a conventional connector generally comprises a housing 11, a base 12 and a plurality of terminals 13. On the base 12 are formed a plurality of inserting holes 121 arranged in a line and provided for insertion of the respective terminals 13, and both ends of the respective terminals 13 will protrude out of the base 12 after being inserted therein. And then the base 12 is inserted in the housing 11. However, this connector still has the following shortcomings that need to be improved.

The connector generally serves as an electrical connection between an electronic product and its peripheral equipment, the more functions the peripheral equipment has, the more the number of terminals increases. If there are too many terminals 13 arranged in a base 12, the interval between the terminals 13 will be two narrow, thus probably resulting in a short circuit. On the other hand, the inserting holes 121 of the base 12 are aligned to one another, the number of the inserting holes 121 must be limited in order to prevent the terminals 13 from contacting each other, and the number of the terminals 13 is also be limited to the number of the inserting holes 121, as a result, the number of the peripheral equipments will also be limited.

The present invention has arisen to mitigate and/or obviate the afore-described disadvantages.

### SUMMARY OF THE INVENTION

The primary objective of the present invention is to provide a connector with double row terminals, wherein the two rows of terminals are arranged in a staggered manner, thus not only preventing short circuit but also saving space.

A connector with double row terminals in accordance with the present invention comprises: a base having a first row of inserting holes and a second row of inserting holes, a first row of terminals each having an inserting portion and a soldering portion, the inserting portion being inserted in the first row of inserting holes, a second row of terminals each having an inserting portion and a soldering portion, the inserting portion being inserted in the second row of inserting holes. The soldering portion of the second terminals and the soldering portion of the first row of terminals are oppositely arranged, and the two rows of terminals are arranged in a staggered manner.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a conventional connector;

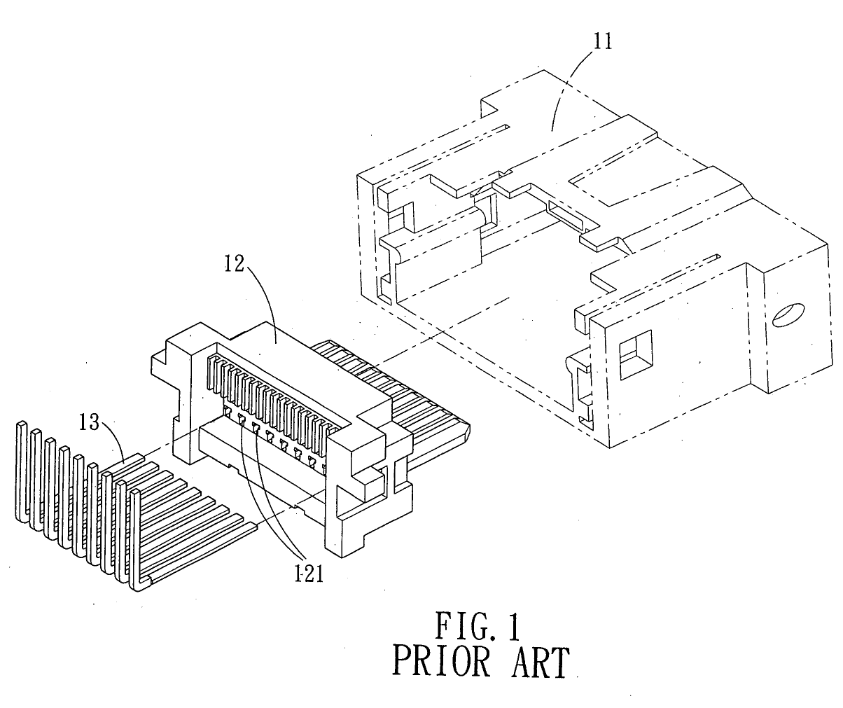

FIG. 2 is an assembly view of a conventional connector;

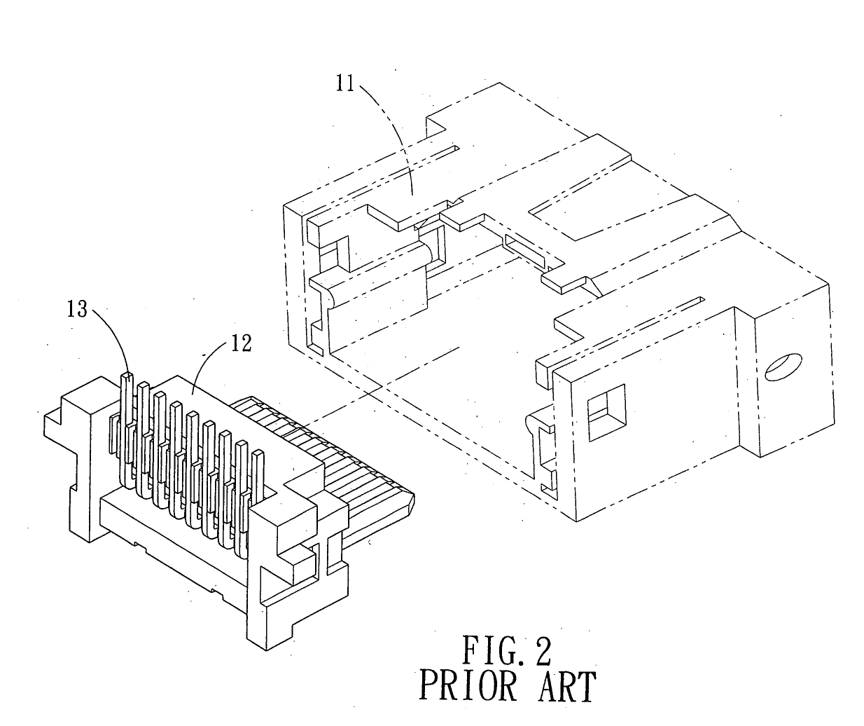

FIG. 3 is an exploded view of a connector in accordance with the present invention;

FIG. 4 is an assembly view of the connector in accordance with the present invention;

FIG. 5 is an exploded view of a connector in accordance with another embodiment of the present invention.

### DETAILED DESCRIPTION OF THE PREFERRED EMBODIMENTS

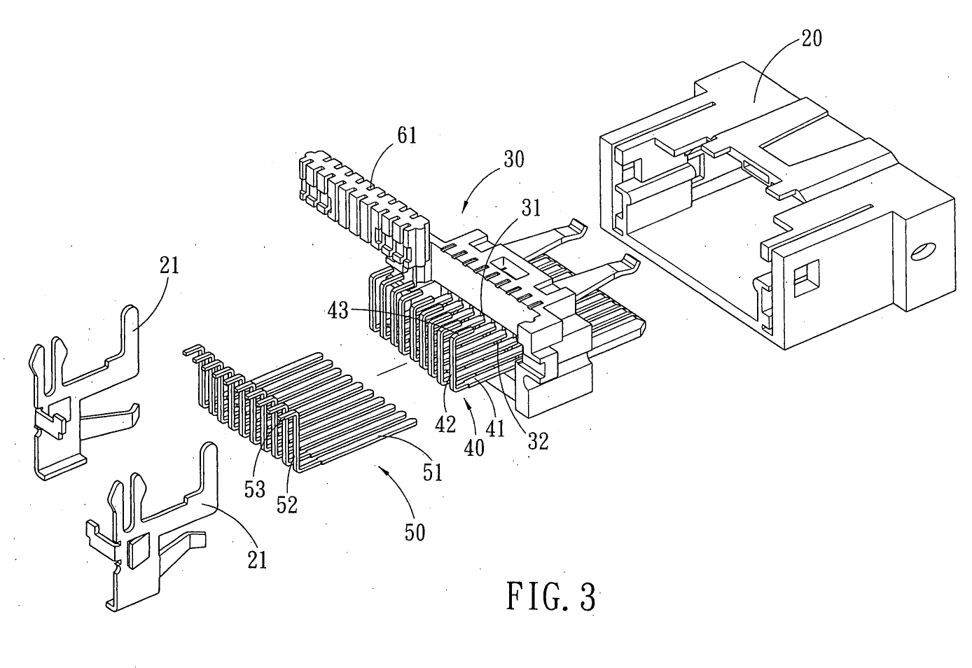

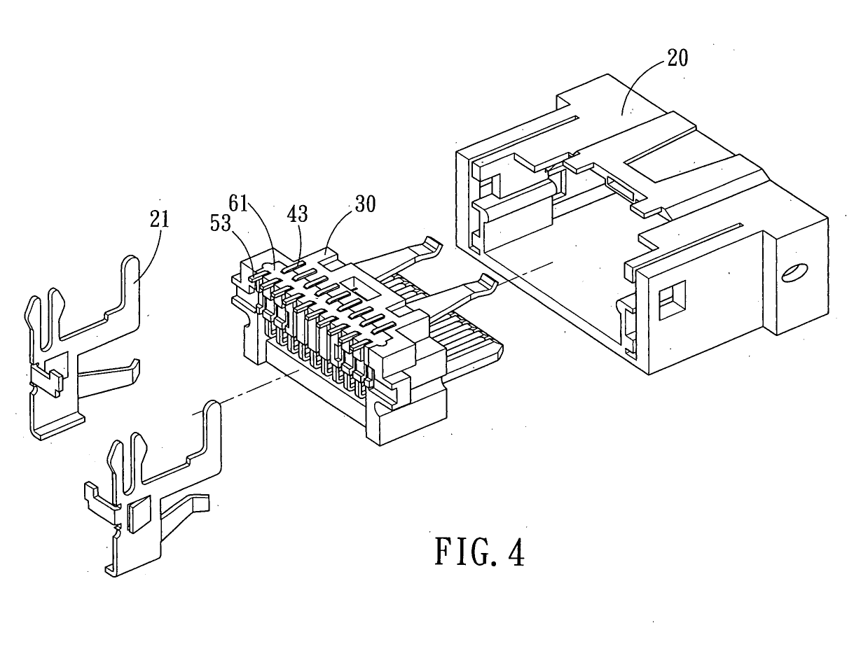

Referring to FIGS. 3 and 4, a connector with double row terminals comprises a base 30, a first row of terminals 40 and a second row of terminals 50.

The base 30 comprises a first row of inserting holes 31 and a second row of inserting holes 32 that are located at an upper and a lower portion thereof and arranged in a staggered manner. The base 30 is positioned in the housing 20 by means of a pair of elastic members 21.

The first row of terminals 40 each is a L-shaped structure having a long inserting portion 41 and a short inserting portion 42, to the end of the short inserting portion 42 is connected a soldering portion 43, and the long inserting portion 41 of the first row of terminals 40 is inserted in the first row of inserting holes 31 of the base 30.

The second row of terminals 50 is a L-shaped structure having a long inserting portion 51 and a short inserting portion 52, to the end of the short inserting portion 52 is connected a soldering portion 53, and the long inserting portion 51 of the second row of terminals 50 is inserted in the second row of inserting holes 32 of the base 30. When the first row of terminals 40 and the second row of terminals 50 are positioned, the soldering portion 53 of the second terminals 50 and the soldering portion 43 of the first row of terminals 40 will extend oppositely on a surface of the base 30.

In addition, after the first row of terminals 40 and the second row of terminals 50 are inserted in their corresponding inserting holes, a lock block 61 can be arranged between the short inserting portions 42 and 52 for further improving the fixation of the first row of terminals 40 and the second row of terminals 50.

Since the first row of terminals 40 and the second row of terminals 50 are arranged in a staggered manner, the interval between the respective terminals will be increased, consequently, no short circuit will occur. Furthermore, the soldering portion 53 of the second terminals 50 and the soldering portion 43 of the first row of terminals 40 are oppositely arranged, thus saving space.

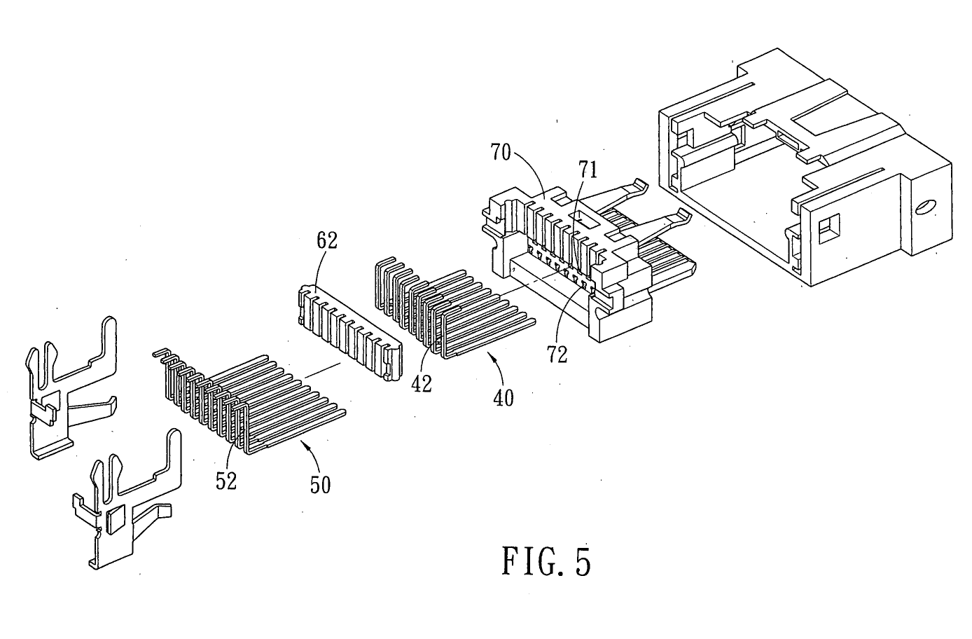

It will be noted that, as shown in FIG. 5, after the first row of terminals 40 and the second row of terminals 50 are inserted in the base 70, another type of lock block 62 can be arranged between the short inserting portions 42 and 52. The base 70 also necessarily changes in structure for matching with the lock block 62, but something unchanged is that the base 70 still has a first row of inserting holes 71 and a second row of inserting holes 72 for insertion of the first row of terminals 40 and the second row of terminals 50.

While we have shown and described various embodiments in accordance with the present invention, it should be clear to those skilled in the art that further embodiments may be made without departing from the scope of the present invention.

What is claimed is:

1. A connector with double row terminals comprising:
a housing;
a base having a first row of inserting holes and a second row of inserting holes;
a first row of terminals each having a long inserting portion, a short inserting portion, and a soldering portion formed at an end of the short inserting portion, the long inserting portion being inserted in the first row of inserting holes;
a second row of terminals each having a long inserting portion, a short inserting portion, and a soldering portion formed at an end of the short inserting portion, the long inserting portion being inserted in the second row of inserting holes; and
a lock block arranged between the short inserting portion of the first row of terminals and that of the second row of terminals for improving the fixation between the first row of terminals and the second row of terminals;
wherein the base is positioned in the housing by a pair of elastic members, the first row of inserting holes are staggered with respect to the second row of inserting holes, so that the first row of terminals are staggered with respect to the second row of terminals, and the soldering portion of the second terminals and the soldering portion of the first row of terminals are oppositely arranged.
